(19) United States
(12) Patent Application Publication
(10) Pub. No.: US 2024/0092978 A1
(43) Pub. Date: Mar. 21, 2024

(54) SPREADABLE GRANULES, USE OF SAME AND GRASS LAWN OR ARTIFICIAL GRASS LAWN WITH SUCH SPREADABLE GRANULES AS INFILL GRANULES

(71) Applicants: TECNARO Gesellschaft zur industriellen Anwendung nachwachsender Rohstoffe mbH, Ilsfeld (DE); Morton Extrusionstechnik GmbH, Abtsteinach (DE)

(72) Inventors: Juergen PFITZER, Beilstein (DE); Helmut NAEGELE, Brackenheim (DE); Michael SCHWEIZER, Freiberg (DE); Dirk SCHAWALLER, Ilsfeld (DE); Lena SCHOLZ, Erdmannhausen (DE); Michael HAEBERLE, Besigheim (DE); Georgios MOURGAS, Flein (DE); Eric HABIB, Montreal (CA); Ulrich BERGHAUS, Troisdorf (DE)

(73) Assignees: TECNARO Gesellschaft zur industriellen Anwendung nachwachsender Rohstoffe mbH, Ilsfeld (DE); Morton Extrusionstechnik GmbH, Abtsteinach (DE)

(21) Appl. No.: 18/520,332

(22) Filed: Nov. 27, 2023

Related U.S. Application Data
(63) Continuation of application No. PCT/EP2022/063982, filed on May 24, 2022.

(30) Foreign Application Priority Data
May 26, 2021 (DE) 10 2021 113 612.1

(51) Int. Cl. C08J 3/12; E01C 13/08

(52) U.S. Cl. CPC C08J 3/124; E01C 13/08; C08J 2300/16; C08J 2300/26; C08J 2307/00

(57) ABSTRACT

Spreadable granules as infill granules for grass and artificial turf fields are proposed, which granules have a polymer matrix with a percentage between 10% by mass and 100% by mass of at least one biodegradable polymer and at least one filler from the group of natural fillers, embedded in the polymer matrix with the at least one biodegradable polymer. The invention provides for the spreadable granules to have at least one filler from the group including comminuted fruit kernels. In addition, the invention relates to the use of such spreadable granules as infill granules for grass and artificial turf fields, as a spacer material for the storage of construction materials, such as, e.g., floor covering materials, and as grit for road maintenance in winter.

This nonprovisional application is a continuation of International Application No. PCT/EP2022/063982, which was filed on May 24, 2022, and which claims priority to German Patent Application No. 10 2021 113 612.1, which was filed in Germany on May 26, 2021, and which are both herein incorporated by reference.

### BACKGROUND OF THE INVENTION

### Field of the Invention

The present invention relates to spreadable granules suitable for use as infill granules for grass and artificial turf fields, wherein the spreadable granules have a polymer matrix with a percentage between 10% by mass and 100% by mass of at least one biodegradable polymer and at least one filler from the group of natural fillers, embedded in the polymer matrix with the at least one biodegradable polymer. The invention relates further to the use of such spreadable granules and to a grass or artificial turf field to which such spreadable granules are applied as infill granules.

### Description of the Background Art

Grass and artificial turf fields are widely used, particularly in the form of sports fields, such as soccer fields, hockey fields, tennis courts, rugby fields, and the like. Moreover, generic grass and artificial turf fields are known, e.g., in the form of riding and equestrian sports arenas, dog training areas, or places generally used for keeping animals.

The grass and artificial turf fields must meet a wide range of requirements in this connection, wherein the focus is particularly on a high environmental friendliness. Moreover, if the grass or artificial turf fields are used as sports fields, their sports technical properties must have a profile tailored to the respective sport and comply with the relevant standards and regulations. Thus, for example, the shock absorption for soccer must be between 55% and 65%, while at the same time the energy return must be in the range of 38% to 43% in order to be considered for a subsequent certification. Moreover, the vertical deformation must not exceed 9 mm. To minimize the risk of injury to the user, the rotational resistance must not be less than 25 Nm and not more than 50 Nm. The aforementioned values can be obtained from the corresponding standards or test specifications, such as, e.g., DIN 18035-7 “Sports grounds—Part 7: Synthetic turf areas” or DIN EN 14808 “Surfaces for sports areas—Determination of shock absorption.” The maximum water infiltration rate of greater than 500 mm/h, which is to be determined in accordance with DIN EN 12616 “Surfaces for sports areas—Determination of water infiltration rate,” is also important.

In addition to natural grass fields, artificial turf fields have recently become increasingly important in order to reduce in particular the maintenance costs associated with the care of natural grass and the resulting consumption of resources (such as water, fertilizer, etc.). Various synthetic turf systems are used in the construction of new sports fields, which compared to natural grass offer a low-maintenance, weed-free surface that does not need to be watered or fertilized and is ready for use largely regardless of the weather. Artificial turf fields usually have a multilayer structure comprising various components, wherein an elastic layer or a bonded elastic base layer is often connected to a substrate (e.g., made of a sub-base, a base layer, and possibly an asphalt layer). The elastic layer is followed in turn by a stabilizing backing layer on which the actual synthetic turf is located. The latter consists primarily of fibers that are woven into a carpet. The artificial turf fields used in Germany are based on the DIN 18035-7 and DIN EN 15330-1 standards. The fiber layer is usually additionally filled with infill granules, such as, e.g., sand and/or rubber granules, as is also the case with natural grass fields.

The elastic layer of artificial turf fields serves, on the one hand, to level out any unevenness in the underlying substrate, so that a completely flat, water-permeable surface is created. At the same time, the elastic layer ensures shock absorption due to cushioning during use. In Germany, such an elastic layer is generally provided for synthetic turf fields in accordance with the aforementioned DIN 18035-7 standard, wherein its layer thickness can usually vary between about 30 mm and about 35 mm. Outside Germany, the thickness of the elastic layer is usually less and generally less than about 25 mm, wherein, in some cases, the elastic layer is dispensed with completely. In this case, the lack of elasticity is compensated for by a larger quantity of infill granules. Plastic fibers, e.g., made of polyethylene (PE), are currently primarily used for the fiber component of synthetic turf, wherein a second—shorter—fiber component can also be used as a support structure, which ensures an upright position of the actual fibers. Due to the higher strength, sometimes polypropylene (PP) or likewise PE is currently used as a supporting fiber. To produce the fiber component, fiber filaments are tufted onto a backing fabric, which is then laid on the elastic layer.

In order to meet the already mentioned DIN 18035-7 and DIN EN 14808 standards, infill granules are an important component for artificial turf fields but also for natural grass fields, wherein they can be used in particular to achieve the required force reduction, vertical deformation, and rotational resistance (see above). Moreover, the infill granules contribute significantly to ball bounce and ball roll behavior, as is necessary when the (artificial) turf field is used for ball sports. Further, the infill granules can extend the life span of artificial turf fields by reducing their wear during use. The infill granules further should be sufficiently weather- and UV-resistant to fulfill their functions over longer periods of time.

With regard to the type of infill granules currently used for grass and artificial turf fields, which are also referred to as “infill,” mineral infill granules, on the one hand, and combinations of mineral and synthetically produced infill granules, on the other, are used primarily, wherein the latter are formed from resilient, usually organic fillers. Quartz sand is often used as mineral infill granules, which increases the turfs rotational resistance and slip resistance and, in the case of artificial turf, weighs it down and ensures the stabilization of the fibers. However, the usually sharp-edged sand particles pose a risk of injury in terms of skin abrasions and such sands have a very high weight, which makes both their transportation and application to the (artificial) turf field costly. Synthetic infill granules, in contrast, provide the necessary cushioning and, in the case of sports fields, the other properties to achieve an appropriate sports functionality. Injuries can thus be prevented and a pleasant “playing feel” imparted.

For reasons of cost, the currently known synthetic infill granules for grass and artificial turf fields are primarily made from recycled styrene-butadiene rubber (SBR), which is obtained from used tires. Due to the dark coloration of such SBR granules, the surface temperatures of the grass fields sprinkled with them are increased, which is a problem particularly in the case of synthetic turf fields, which in any case often have a higher surface temperature than natural grass fields. Thus, on hot summer days, at temperatures of up to around 40° C., on the surface of artificial turf fields sprinkled with SBR granules, temperatures of up to 75° C. have been measured on the synthetic turf surface, which makes it practically impossible to use the artificial turf field. Moreover, at relatively high temperatures, as prevail during the summer, the odor typical of SBR is dominant, which is why cooling the synthetic turf field in summer is indispensable. To counteract this, SBR granules intended as infill granules have already been provided with coatings based on polyurethanes (PUR) of a lighter color, which, however, wear off relatively quickly due to the mechanical load during intensive use. In addition to SBR as the main component of such infill granules, known infill granules also contain various extender oils, carbon black, antioxidants, and metallic components such as, for example, zinc, copper, or chromium as additives, due to the health and environmental effects of which the use of recycled SBR as infill granules for (artificial) turf fields has recently been the subject of controversial debate, wherein, in particular, the polycyclic aromatic hydrocarbons (PAHs) contained in the extender oils play an important role.

As an alternative to SBR, additionally, infill granules based on ethylene propylene diene rubber (EPDM) are known for (artificial) turf fields, wherein EPDM can also exhibit good weather resistance with a largely constant elasticity with use of certain stabilizers. A further advantage of EPDM over SBR recyclates is that the color of the granules can be freely selected during production. In addition to a significantly higher price, however, it is disadvantageous that EPDM, like SBR granules, is a cross-linked elastomer, which means that it cannot be remelted. This limits the choice of usable recycling technologies and thus the overall environmental friendliness.

Thermoplastic elastomers (TPE) can be used as a further option for primarily elastic infill granules; the elastic component of these elastomers is able to provide the corresponding mechanical properties, whereas the thermoplastic component ensures that the polymer can be melted. In this way, processing of TPE analogous to pure thermoplastics and a better recyclability compared with SBR and EPDM are possible. However, TPEs not only represent the most expensive materials for infill granules by far, but it has also been shown with the styrene-based TPEs currently used for infill granules that the infill granules begin to soften at high ambient temperatures. This leads to a sticky consistency of the TPE, which adheres to clothing and shoes when the (artificial) turf field is used and, in the case of artificial turf, also causes the individual fibers to stick together, so that the artificial turf field is damaged.

A fundamental problem in connection with synthetic infill granules for (artificial) turf fields of the aforementioned types and in general in connection with spreadable granules exposed to the environment is furthermore in particular their unavoidable entry into the environment, which occurs not only during use of the (artificial) turf field, but also merely through environmental influences such as wind, rain, artificial watering, and the like. According to the definition of the German Environment Agency, such spreadable granules fall under the category of “microplastics,” which refers to plastic particles up to 5 mm in size. In this regard, a distinction must be made between so-called primary and secondary microparticles. Whereas primary microparticles are produced specifically for different applications, secondary microparticles are created unintentionally by physical, chemical, or biological decomposition and fragmentation of plastic parts. Consequently, in the case of (artificial) turf fields provided with such infill granules, the inevitable result is a discharging of both primary microplastics in the form of the “infill” itself and secondary microplastics via fiber abrasion and/or crushing of the “infill.” How high the discharging is in individual cases depends on various factors, such as, among others, the type and quantity and, if applicable, the age of the infill granules, the fiber structure and geometry, as well as the length of the (artificial) turf, the type and intensity of use, care and maintenance of the (artificial) turf field, the natural conditions (e.g., in flood areas, in wind corridors, etc.), and local weather events. The main discharging paths for spreadable granules were identified here primarily as rain and wind, including artificial watering (around 70%), drainage (around 15%), snow removal (around 10%), and a not inconsiderable removal via clothing and shoes. Within the territory of the European Union, the largest share in terms of intentionally used microplastics is attributed to the currently used synthetic infill granules for synthetic turf systems, wherein according to estimates of the European Chemicals Agency (ECHA) a total of around 100,000 tons of spreadable granules are used annually. At the same time, these spreadable granules are the largest source of microplastics discharged into the environment, wherein a discharge of around 16,000 tons per year is assumed, so that a release rate of around 16% is calculated.

However, the discharge of microplastics into the environment, whether into aquatic systems or soil, should be prevented as far as possible due to both the environment- and health-related consequences for flora and fauna. Thus, for example, such particles can be mistaken for food and ingested by animals, which leads to damage and irritation of the intestinal tract. If the particles are not excreted, the animal retains a feeling of satiety, and this leads to deficiency symptoms or even starvation. A further problem is the migration of harmful components from the plastic, which can enter the food chain via the discharging, such as, for example, the aforementioned extender oils, which are mainly contained in SBR recyclates. The latter can in turn contain polycyclic aromatic hydrocarbons (PAHs), which are sometimes classified as carcinogenic, mutagenic, and/or toxic to reproduction. Moreover, PAHs can be persistent; i.e., they remain in the environment for a long time or are poorly degraded. In addition, they are able to bioaccumulate, thus to accumulate in the fatty tissue of humans and animals, which makes their health-damaging effects particularly severe. Further, reduced growth and negative effects on the root system have been observed in plants in relation to spreadable granules made of EPDM. In addition, microparticles can also have a direct effect on soil organisms and consequently on soil functionality, wherein, among other things, reduced reproduction and reduced body length of fiber worms, so-called nematodes, were observed as a result of the influence of microplastics. Particularly with regard to SBR recyclates from used tires, in addition heavy metals such as, e.g., zinc, copper, and chromium can also enter the environment, as a result of which the corresponding limit values in soil or water can be exceeded.

Recently, there has been increasing research into alternatives for so-called “infill” materials, which are primarily used as infill granules for (artificial) turf fields, but can also be used for other applications, and which are not of synthetic origin but are based on natural resources. The most widely used natural flexible infill granules in this regard is cork obtained from the cork oak, which can be reinforced with coconut fibers. Cork's low density, high strength, low wear, and low heat absorption when exposed to sunlight, among other things, are advantageous for use especially for artificial turf fields. A disadvantage, however, is the widely varying properties of cork under different weather conditions. Thus, e.g., the cork granules can more or less harden at low temperatures in the freezing range. During heavy rainfall, the cork can easily be discharged in large quantities due to its low density. In summer, in contrast, the cork granules tend to dry out, so that with dust formation they stick to clothing and shoes and lose their elasticity. Therefore, if cork granules are used, artificial watering of the (artificial) turf field at higher temperatures is essential. Compared to the synthetic infill granules described above, the durability of cork is also much shorter, so that the cork granules have to be replaced frequently.

Finally, spreadable granules with a polymer matrix formed at least partially from biodegradable polymers are also known from the literature; these have the decisive advantage that while having a sufficient life span, they can be broken down, largely without leaving residues, into breakdown and/or metabolic products that are harmless both in terms of health and ecotoxicology, in order to ensure a high environmental friendliness without the introduction of long-term stable or even ecotoxic microplastic particles. If such spreadable granules are used in particular as infill granules for (artificial) turf fields, they usually also contain a not inconsiderable amount of one or more fillers in order to keep the polymer component, which by contrast is generally much more expensive, within limits. Thus, for example, US 2020/0165784 A1 describes an artificial turf field for sports purposes, which, on the one hand, has a substrate which comprises artificial grass fibers and, on the other hand, infill granules which are made from biobased and/or biodegradable plastic. Examples of such plastics comprise polylactide (PLA), polybutylene succinate (PBS), polycaprolactone (PCL), poly(3-hydroxybutyrate-co-3-hydroxyvalerate) (PHBV), polyhydroxyalkanoate (PHA), polyhydroxybutyrate (PHB), polyethylene (PE), polypropylene (PP), or derivatives thereof. The polymer matrix of the infill granules can be mixed with various fillers, wherein both natural fillers in the form of fibers or fine particles, such as starch, cork, coconut, hemp, grass, cellulose, reeds, hay, straw, or also cardboard, and mineral fillers, such as zeolites, CaCO₃, SiO₂, Al₂O₃, MgO, chalk, kaolin, or talc, can be provided.

US 2018/0179711 A1 also deals with an artificial turf field that has a substrate comprising polymer-based artificial turf fibers, on the one hand, and infill granules, on the other. The infill granules consist of composite particles containing between 10% and 90% by mass of a thermoplastic polymer, on the one hand, and between 10% and 80% by mass of cellulose fibers, on the other. Both conventional synthetic and biobased and biodegradable polymers, such as, for example, starch-based polymers, polylactide (PLA), poly-3-hydroxybutyrate, or biobased polyethylene, can be considered for the polymer matrix of the infill granules. In addition to the above-mentioned cellulose fibers, other filler fibers can be added, such as those from the group of various softwood and hardwood, bamboo, rattan, rice and wheat straw, rice husks, bagasse, cotton stalks, jute, hemp, flax, kenaf, milkweed, grass, banana trees, coconut shells, walnut shells, pecan shells, or other nut shells, and peanut shells. Moreover, mineral fillers such as mussel shells or CaCO₃ from other sources, mica, talc, barite, or ceramics can be provided (claims 10 and 11).

WO 2018/016956 A1 discloses a further artificial turf field for sports purposes, which comprises a substrate with artificial grass fibers, on the one hand, and infill granules, on the other. In this case as well, the polymer matrix of the granule particles is made of biobased and biodegradable polymers, such as in particular polylactide and its derivatives, polybutylene succinate (PBS), polycaprolactone (PCL), poly(3-hydroxybutyrate-co-3-hydroxyvalerate) (PHBV), polyhydroxyalkanoate (PHA), or polyhydroxybutyrate (PHB). Moreover, various fillers are also provided here, which largely correspond to those of US 2020/0165784 A1 cited above.

Finally, US 2019/0316303 A1 describes a further artificial turf field with infill granules containing between 10% and 40% by mass of natural fibers mixed into rubber, which fibers are selected from the group comprising hemp, cotton, burlap, sisal, elephant grass, and/or cellulose fibers, as well as a method for its manufacture.

As far as the fillers or fibers of the spreadable granules proposed in the prior art are concerned, these comprise, on the one hand, very soft plant fibers, compared to the polymer matrix of the granule particles, such as wood, nut shell, or leaf fibers, with which the material costs can be reduced without increasing the weight of the infill granules in any significant way, but which are usually not able to give the granule particles sufficient hardness to be able to adapt them to the respective sports functionality, as explained further above. With regard to fillers with a very high hardness compared to the polymer matrix of the granule particles, only mineral fillers such as zeolites, CaCO₃, SiO₂, Al₂O₃, MgO, chalk, kaolin, or talc, or mussel shells, or CaCO₃ from other sources, mica, talc, barite, or ceramics are proposed. The hardness of the infill granules can be adapted to different sports functionalities with fillers of this type, but such fillers have a number of disadvantages. Thus, on the one hand, their weight is significantly higher than that of the polymer matrix, which makes both their transportation and application, e.g., as infill granules to the (artificial) turf field, costly. On the other hand, they are not biodegradable and therefore accumulate over time, which is to be avoided, especially in artificial turf fields. Moreover, mineral fillers generally have very sharp-edged shapes and therefore pose an increased risk of injury, e.g., with regard to skin abrasions, especially when used as infill granules for (artificial) turf fields. On the other hand, they have a highly abrasive effect and thus cause damage to artificial turf fields, resulting in shorter life spans of the same.

### SUMMARY OF THE INVENTION

It is therefore an object of the present invention to provide a simple and cost-effective spreadable granules suitable for use as infill granules for grass and artificial turf fields, which have the greatest environmental friendliness possible and are also particularly suitable for sports fields by satisfying the above-described sports technical properties, while at least most extensively avoiding the aforementioned disadvantages. It is directed further to the use of such spreadable granules and to a grass or artificial turf field on which such spreadable granules are applied as infill granules.

According to the invention, the first part of this object is achieved with spreadable granules of the aforementioned type in that the spreadable granules have at least one filler from the group including comminuted fruit kernels.

To achieve said object, the invention further provides, in the case of a grass or artificial turf field to which infill granules are applied, that the infill granules are spreadable granules of the aforementioned type.

Also, in order to achieve this object, the invention provides for the use of such spreadable granules, in particular as infill granules for grass and artificial turf fields, but also as spacer material for the storage of construction materials, in particular in the form of floor covering materials, and/or as grit for road maintenance in winter.

### DETAILED DESCRIPTION

The spreadable granules of the invention, which can be scattered on grass or artificial turf fields, for example, as infill granules in a manner known per se, are, on the one hand, sufficiently stable and largely water-insoluble to fulfill their function even after prolonged exposure to sunlight, precipitation, frost, and other external influences. In particular, it was found that the spreadable granules of the invention are able to completely fulfill the sports technical requirements not only for natural grass fields but in particular also for artificial turf fields, wherein further they provide the necessary stabilizing effect of the fiber layer, especially in the case of artificial turf fields. They can therefore assume in an excellent manner to the same extent as the already known synthetic infill granules the functions of the positional stability of the artificial turf, the protection of the base layer of the artificial turf, the stabilization of the fibers of the artificial turf, the optimization of shock absorption, energy return, and rotational resistance during the practice of any sport, and/or the optimization of ball rebound during the practice of ball sports.

On the other hand, in view of the fact that, as mentioned above, a not inconsiderable amount is always discharged from the (artificial) turf field or in the event of further advantageous uses otherwise enters the environment, the invention makes it possible that the spreadable granules decompose largely without leaving residues into breakdown and/or metabolic products that are harmless both in terms of health and ecotoxicology in order to ensure impeccable environmental friendliness without the introduction of long-term stable or even ecotoxic microplastic particles. “Biodegradable” in the context of the invention means that the at least one polymer of the spreadable granules can be completely degraded by microorganisms, such as bacteria and fungi, or by enzymes. In this regard, the microorganisms use the polymer as food or as a source of energy. During this metabolization, the polymers must be completely broken down under aerobic conditions into carbon dioxide (CO₂), water (H₂O), mineral salts, and new biomass. In the absence of oxygen, therefore, under anaerobic conditions, a complete conversion into carbon dioxide, mineral salts, biomass, and methane (CH₄) must take place. The at least one biodegradable polymer of the spreadable granules can preferably be compostable according to the standard DIN EN 13432 or the US standard ASTM D6400, wherein composting is a special case of biodegradability. In industrial composting, the compostable polymer must be completely broken down within a comparatively short period of time of a maximum of two years under controlled conditions (i.e., a temperature of around 60° C. and a defined humidity).

The comminuted fruit kernels used according to the invention as a filler for the spreadable granules offer a number of advantages, especially for the use of the spreadable granules as infill granules both for grass and in particular for artificial turf fields, but also for other applications (see below in this regard), wherein the following aspects should be mentioned as examples: Thus, the fillers of the invention based on comminuted fruit kernels, like the matrix polymer of the spreadable granules, are completely biodegradable and thus neither accumulate over time nor do they in turn degrade into environmentally harmful micro- or nanoparticles. They are also freely available in large quantities, because they have so far been almost exclusively composted or otherwise disposed of due to a lack of technical use, so that no additional agricultural land is required for their production, as is usually the case with the widely used plant fibers. Moreover, the fillers of the invention, which are based on comminuted fruit kernels, are able to give the spreadable granules a greater hardness compared to plant fibers, so that they can be adapted to the respective sports functionality when used as infill granules for (artificial) turf fields, in particular without increasing their weight to any significant extent, as is the case with the known mineral fillers. In addition, the fillers of the invention based on comminuted fruit kernels are less sharp-edged than such mineral particles and thus reduce the risk of injury to the athlete when the spreadable granules are used as infill granules for (artificial) turf fields, on the one hand, and, on the other hand, artificial turf fields in particular are not excessively stressed due to the lower abrasiveness of the fillers of the invention and thus have a longer life span.

For the aforementioned reasons, the at least one filler from the group of comminuted fruit kernels can have a higher hardness than the hardness of the polymer matrix, wherein, depending on the matrix polymer used for the spreadable granules and on the intended use thereof, it is of course also possible in principle conversely to use additional fruit kernels.

Examples of suitable fruit kernels, as they can be used in comminuted form as a filler for the spreadable granules of the invention, comprise, although not exclusively, the kernels from olives, cherries, apricots, mirabelle plums, plums, damsons, peaches, nectarines, dates, almonds, coffee berries, mangoes, apples, pears, oranges, grapes, melons, lemons, avocados, papayas, and the like. Moreover, fillers with mixtures of various comminuted fruit kernels, such as, e.g., olive stone flour, cherry pit flour, apricot kernel flour, and the like, can also be used, e.g., to adjust the desired hardness of the spreadable granules.

In an example, the polymer matrix of the spreadable granules can have a percentage of the at least one biodegradable polymer of at least about 20% by mass, in particular of at least about 30% by mass, preferably of at least about 40% by mass, most preferably of at least about 50% by mass. Particularly preferred are percentages of the at least one biodegradable polymer of at least about 60% by mass, in particular of at least about 70% by mass, preferably of at least about 80% by mass, most preferably of at least 90% by mass, wherein the percentage of the at least one biodegradable polymer can also be at least almost 100% by mass.

In an example, it can be provided that at least one biodegradable polymer of the polymer matrix of the spreadable granules is selected from the group of biobased polymers, which are polymers that can be produced in whole or in part from renewable raw materials, as will be explained in more detail below.

The polymer matrix of the spreadable granules should expediently further have a water solubility of at most about 0.5 g/L, e.g., of at most about 0.3 g/L, in particular of at most about 0.1 g/L, so that the spreadable granules are largely insoluble in water and dimensionally stable over a longer period of time under the influence of precipitation, such as rain or snow, and do not dissolve.

In order to ensure perfect sports technical properties in particular, it proves to be advantageous further if the polymer matrix of the spreadable granules has a modulus of elasticity from about 0.1 GPa to about 8 GPa, in particular from about 0.2 GPa to about 5 GPa.

The polymer matrix of the spreadable granules should moreover have a melting point of at least about 70° C., in particular of at least about 80° C., preferably of at least about 90° C., e.g., of at least about 100° C., in order to prevent the spreadable granules from melting partially or completely even at very high ambient temperatures and/or direct sunlight.

With regard to the biodegradable polymer used for the polymer matrix of the spreadable granules of the invention, it can be provided in an example that at least one biodegradable polymer of the polymer matrix of the spreadable granules is selected from the group of thermoplastic polymers, so that, on the one hand, simple production by means of known thermoplastic processing methods is possible (e.g., by extruding and comminuting the extrudate to form the spreadable granules by means of a cutting tool, which can preferably be done under water for the purpose of producing largely spherical granule particles), and, on the other hand, the spreadable granules can be easily recycled. Advantageous biodegradable polymers comprise in particular those according to the standard DIN EN 13432 cited above, in particular from the group of
polyhydroxyalkanoates, in particular polyhydroxybutyrate (PH B), poly-4-hydroxybutyrate (P4HB), polyhydroxyvalerate (PHV), polyhydroxyacetic acid, poly(3-hydroxybutyrate-co-4-hydroxybutyrate), poly(3-hydroxybutyrate-co-4-hydroxybutyrate), poly(3-hydroxybutyrate-co-4-hydroxybutyrate), polyhydroxyhexanoate (PHH), and/or polyhydroxyoctanoate (PHO);
polylactide (PLA);
starch and/or its derivatives;
polybutylene adipate terephthalate (PBAT), polybutylene succinate (PBS), and/or polybutylene succinate adipate (PBSA);
polysaccharides and/or their derivatives;
lignin and/or its derivatives;
polycaprolactones (PCL); and/or
proteins and/or their derivatives including their blends.

The biodegradable polymers can therefore be those synthesized from monomers. As mentioned above, the biodegradable polymers can advantageously be biobased polymers, such as preferably polylactic acid (PLA), polyhydroxyalkanoates (PHA), e.g., polyhydroxybutyrate (PHB), starch, and/or lignin including their derivatives, etc., as well as non-biobased polymers such as, for example, polybutylene adipate terephthalate (PBAT), polycaprolactones (PCL), etc. Moreover, the biodegradable polymers can also be, e.g., partially biobased, as, e.g., in the case of polybutylene succinate (PBS) or polybutylene succinate adipate (PBSA). Examples of polysaccharide derivatives comprise those, for example, in which functional groups of the natural polymer, e.g., the OH and/or NH₂ groups, are partially or completely substituted, such as, for example, in the case of cellulose esters (e.g., cellulose acetate, cellulose acetate butyrate, cellulose acetate propionate, etc.), starch esters (such as, e.g., starch acetate, acetylated distarch adipate, etc.), or partially deacetylated chitin and its derivatives.

In particular, a number of biodegradable polymers can also be used in the form of a blend or a polymer mixture, each of which can be biobased, non-biobased, and/or partially biobased. This can also prove advantageous in view of the fact that some biodegradable polymers can be processed only with difficulty on conventional thermoplastic processing machines, such as single-screw or twin-screw extruders in particular, and/or the properties of the pure polymers alone are not satisfactory. If, in contrast, a number of polymers are physically mixed in the melt to form a blend, starch-PBAT blends or PLA-PBAT blends can be generated, for example, which can be easily processed. In addition to a possible admixture of additional substances, such as additives, further fillers, and the like (see below in this regard), the advantages of different biodegradable polymers can be combined in this way and any disadvantages, such as, e.g., a dominant brittleness of a blend partner, can be compensated for.

Moreover, in particular, although not exclusively, in the case of use of the spreadable granules as infill granules for sports fields, it can preferably be provided that at least one biodegradable polymer of the polymer matrix of the spreadable granules is selected from the group of elastomeric polymers, in particular from the group of natural rubber (e.g., from rubber plants and/or dandelion milk), in order to give the spreadable granules the desired elasticity in each case, wherein the elastomeric polymers can be mixed in particular with one or more of the above-mentioned thermoplastic polymers in order to set the desired elasticity. In this way, a grass or artificial turf field used for sports purposes in particular can be given a pleasant and safe playing feel in that the mechanical characteristics of the spreadable granules can be modified by selecting the amount of a respective blend partner in their polymer matrix. Moreover, a covalent integration of a soft phase into the at least one biodegradable polymer of the spreadable granules is also conceivable, for example, in order to set the damping or flexible elastic properties. Examples of such a soft phase comprise the integration of low-molecular-weight polyethylene glycols (PEG), which are biodegradable up to an average molecular weight of about 1500 g/mol.

The at least one filler from the group of comminuted fruit kernels of the spreadable granules of the invention can advantageously be present in a percentage of at least about 10% by mass, in particular of at least about 20% by mass, preferably of at least about 30% by mass, in each case based on the total mass of the spreadable granules, wherein the invention also makes it possible to provide significantly higher percentages of comminuted fruit kernels, such as, e.g., at least about 40% by mass, at least about 50% by mass, at least about 60% by mass, or at least about 70% by mass, e.g., up to about 80% by mass, again in each case based on the total mass of the spreadable granules.

The at least one filler from the group of comminuted fruit kernels of the spreadable granules of the invention can advantageously also have a particle size of at least about 0.01 mm, in particular of at least about 0.1 mm, preferably of at least about 0.3 mm, e.g., of at least about 0.5 mm; and/or a particle size of at most about 1.5 mm, in particular of at most about 1 mm, preferably of at most about 0.8 mm.

According to a refinement, it can be provided that the spreadable granules have at least one further filler, embedded in the polymer matrix with the at least one biodegradable polymer. The filler can be substantially powdery, particulate, or fibrous fillers which, for the reasons mentioned above, should for their part preferably be of natural origin and biodegradable. Examples of possible additional fillers comprise, in particular, fibrous or particulate or flour-like natural substances such as cellulose, lignin, wood, reeds, miscanthus, hemp, seaweed, nut shells, and the like, wherein depending on the area of application of the spreadable granules, for example, mineral substances such as, e.g., ash can also be used. Particularly preferred examples of further fillers comprise ground nut shells, e.g., of walnuts, hazelnuts, pistachios, dates, almonds, Brazil nuts, pecan nuts, macadamia nuts, cashew nuts, horse chestnuts, sweet chestnuts (roasted chestnuts), acorns, and the like, as well as ground shells of flower seeds, such as, e.g., sunflower seeds and the like. Further, it is conceivable, for example, to use other fillers made from plant-based vulcanizates, e.g., based on dandelion milk, furfuryl alcohol, etc., or from higher-melting bioplastics or their recyclates.

Moreover, additives known per se, such as, for example, processing aids, UV stabilizers, flame retardants, dyes and pigments, ecologically harmless plasticizers, such as, e.g., in the form of natural oils or waxes, and the like, can of course be added to the polymer matrix of the spreadable granules.

As already indicated, it can prove advantageous for many uses of the spreadable granules if these have rounded, in particular substantially spherical, granule particles, which applies in particular to use for grass and artificial turf fields in the form of sports fields, in order to ideally meet the sports technical requirements and to prevent the risk of injury caused by sharp-edged granule particles, such as skin abrasions or the like. As also already indicated, such substantially round granule particles can be produced, for example, by cutting the extrudates extruded, e.g., by means of a die unit of a single- or multi-screw extruder, to length by underwater granulation to form the granule particles, wherein they are cut, e.g., under water using a rotating cutting tool.

Depending on the intended use, the spreadable granules can further preferably have a granule particle size of at least about 1.0 mm, in particular of at least about 1.5 mm, preferably of at least about 2.0 mm, and/or at most about 5.0 mm, in particular of at most about 4.5 mm, preferably of at most about 4.0 mm, wherein the particle size can be set, e.g., by the selected die cross section of a single- or multi-screw extruder, on the one hand, and by the rotational speed of a rotating cutting blade, on the other.

As mentioned above, the spreadable granules of the invention are particularly suitable as infill granules for grass and artificial turf fields, wherein it can also certainly be used wherever there was previously a risk that plastic granules exposed to the environment enter the environment and, in particular, cause harmful entry of so-called microplastics there.

Thus, a further advantageous field of application of the spreadable granules of the invention is, for example, as a spacer material for the storage of construction materials, in particular in the form of floor covering materials, such as, e.g., concrete products, mineral coverings, artificial stones, artificial slabs, ceramic tiles, natural stones, natural stone slabs, and the like. In this context, it is already known to arrange spreadable granules made of synthetic plastics between the individual layers stacked on top of each other as a spacer material when storing such construction materials in order to allow air circulation between the individual layers, on the one hand, so that moisture can escape from the gaps and penetration of moisture into the stacks is reduced as a result of lower capillary forces. On the other hand, such spreadable granules serve as spacer materials to protect the construction materials from mechanical damage, in particular from scratching their visible sides.

Furthermore, use of the spreadable granules of the invention as grit for road maintenance in winter is conceivable in that it can be applied to snow and ice on public roads or sidewalks to increase friction.

In the case of a grass or artificial turf field of the invention, to which the spreadable granules of the type described above have been applied as infill granules, the average filling height of the spreadable granules can preferably be between about 1.0 mm and about 2.5 mm, in particular between about 1.3 mm and about 2.0 mm.

According to a refinement of such a grass or artificial turf field of the invention, it can further be envisaged that it is provided with an antimicrobial finish in order to delay the biodegradation of the spreadable granules on the grass and artificial turf field, so that the biodegradation of the spreadable granules can take place primarily when the latter has been discharged from the (artificial) turf field, whereas on the (artificial) turf field itself the properties of the spreadable granules remain largely unchanged over a long period of time despite environmental influences. For this purpose, the (artificial) turf field can be sprayed, for example, with antimicrobials and/or disinfectants that are harmless to health, or, in the case of an artificial turf field in particular, antimicrobial finishes can be applied to its fibers and/or its elastic layer, e.g., in the form of silver ions or the like incorporated into its polymer matrix.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. Spreadable granules being infill granules for grass and artificial turf fields, the spreadable granules comprising:
a polymer matrix with a percentage between 10% by mass and 100% by mass of at least one biodegradable polymer;
at least one filler from the group of natural fillers, embedded in the polymer matrix with the at least one biodegradable polymer; and
at least one filler from the group of comminuted fruit kernels.

2. The spreadable granules according to claim 1, wherein the at least one filler from the group of comminuted fruit kernels has a higher hardness than a hardness of the polymer matrix.

3. The spreadable granules according to claim 1, wherein at least one filler from the group of comminuted fruit kernels is selected from the group of: kernels from olives, cherries, apricots, mirabelle plums, plums, damsons, peaches, nectarines, dates, almonds, coffee berries, mangoes, apples, pears, oranges, grapes, melons, lemons, avocados, and/or papayas.

4. The spreadable granules according to claim 1, wherein the polymer matrix of the spreadable granules has a percentage of the at least one biodegradable polymer of at least 20% by mass or at least 30% by mass or at least 40% by mass.

5. The spreadable granules according to claim 1, wherein at least one biodegradable polymer of the polymer matrix of the spreadable granules is selected from the group of biobased polymers.

6. The spreadable granules according to claim 1, wherein the polymer matrix of the spreadable granules comprises:
a water solubility of at most 0.5 g/L or of at most 0.1 g/L; and/or
a modulus of elasticity from 0.1 GPa to 8 GPa or from 0.2 GPa to 5 GPa; and/or
a melting point of at least 70° C. or at least 80° C. or at least 90° C.

7. The spreadable granules according to claim 1, wherein at least one biodegradable polymer of the polymer matrix of the spreadable granules is selected from the group of thermoplastic polymers comprising:
polyhydroxyalkanoates, in particular polyhydroxybutyrate (PH B), poly-4-hydroxybutyrate (P4HB), polyhydroxyvalerate (PHV), polyhydroxyacetic acid, poly(3-hydroxybutyrate-co-4-hydroxybutyrate), poly(3-hydroxybutyrate-co-4-hydroxybutyrate), poly(3-hydroxybutyrate-co-4-hydroxybutyrate), polyhydroxyhexanoate (PHH), and/or polyhydroxyoctanoate (PHO);
polylactide (PLA);
starch and/or its derivatives;
polybutylene adipate terephthalate (PBAT), polybutylene succinate (PBS), and/or polybutylene succinate adipate (PBSA);
polysaccharides and/or their derivatives;
lignin and/or its derivatives;
polycaprolactones (PCL); and/or
proteins and/or their derivatives including their blends.

8. The spreadable granules according to claim 1, wherein at least one biodegradable polymer of the polymer matrix of the spreadable granules is selected from the group of elastomeric polymers and/or from the group of natural rubber.

9. The spreadable granules according to claim 1, wherein the at least one filler from the group of comminuted fruit kernels:
is present in a percentage of at least 10% by mass, of at least 20% by mass, or of at least 30% by mass, relative to a total mass of the spreadable granules; and/or
has a particle size of at least 0.01 mm or of at least 0.1 mm or of at least 0.3 mm; and/or
has a particle size of at most 1.5 mm or of at most 1 mm or of at most 0.8 mm.

10. The spreadable granules according to claim 1, wherein the spreadable granules comprise at least one further filler from the group of natural fillers, embedded in the polymer matrix with the at least one biodegradable polymer in the form of cellulose, wood, lignin, reeds, miscanthus, hemp, seaweed, fruit husks and shells, and/or flower seed shells.

11. The spreadable granules according to claim 1, wherein the spreadable granules:
are rounded or substantially spherical granule particles; and/or
have a granule particle size of at least 1.0 mm or of at least 1.5 mm or of at least 2.0 mm; and/or
have a granule particle size of at most about 5.0 mm or at most about 4.5 mm or at most about 4.0 mm.

12. The spreadable granules according to claim 1, wherein the spreadable granules are infill granules for grass and artificial turf fields, are spacer material for storage of construction materials or floor covering materials, and/or are grit for road maintenance in winter.

13. A grass or artificial turf field to which infill granules are applied, wherein the infill granules are the spreadable granules according to claim 1.

14. The grass or artificial turf field according to claim 13, wherein the spreadable granules are applied with an average filling height between 1.0 mm and 2.5 mm or between 1.3 mm and 2.0 mm.

15. The grass or artificial turf field according to claim 13, wherein the grass or artificial turf field is provided with an antimicrobial finish in order to delay a biodegradation of the spreadable granules on the grass and artificial turf field.
